(19) United States
(12) Patent Application Publication
(10) Pub. No.: US 2013/0152727 A1
(43) Pub. Date: Jun. 20, 2013

(54) High Speed, Compliant, Planetary Flywheel Touchdown Bearing

(71) Applicant: U.S.A., as represented by the Administrator of the National Aeronautics and Space Administration, Washington, DC (US)

(72) Inventors: Ralph H. Jansen, Grafton, OH (US); Ronald J. Storozuk, Cleveland, OH (US)

(73) Assignee: U.S.A., as represented by the Administrator of the National Aeronautics and Space Administration, Washington, DC (US)

(21) Appl. No.: 13/714,906

(22) Filed: Dec. 14, 2012

Related U.S. Application Data
(60) Provisional application No. 61/576,446, filed on Dec. 16, 2011.

(51) Int. Cl. F16F 15/30

(52) U.S. Cl. CPC F16F 15/30
USPC 74/572.11

(57) ABSTRACT

A touchdown bearing system is provided to safely spin down a magnetically suspended flywheel rotor from full speed when the magnetic suspension system fails. In one embodiment, a plurality of touchdown wheels are mounted on a rigid support ring in a planetary arrangement. The support ring is mounted to a stationary structure of a flywheel system

### CROSS-REFERENCE TO RELATED APPLICATION

This application claims the benefit of U.S. Provisional Application No. 61/576,446, filed on Dec. 16, 2011. The subject matter of the earlier filed provisional patent application is incorporated herein by its entirety.

### ORIGIN

The invention described herein was made in the performance of work under a NASA contract and is subject to the provisions of Section 305 of the National Aeronautics and Space Act of 1958, Public Law 85-568 (72 Stat. 435; 42 U.S.C. 2457).”

### FIELD

The present invention relates to a touchdown bearing and, more particularly, to a touchdown bearing that provides an auxiliary mechanical bearing system for magnetically suspended flywheel systems.

### BACKGROUND

Flywheel systems can be used to store energy and provide momentum control for terrestrial and space applications. The rotor is the key energy storage component of the flywheel and is supported on a bearing system. Magnetic suspension is used in high performance flywheel systems to allow high speed operation. Mechanical touchdown bearings are required as a back-up bearing system when power is shuts off, the forces on the flywheel exceed the magnetic suspension capability, or the magnetic suspension system fails.

However, with mechanical touchdown bearings, the flywheel system may safely operate after experiencing loads greater than the magnetic suspensions system force capacity or when the magnetic suspension system fails.

### SUMMARY

Certain embodiments of the present invention may provide solutions to the problems and needs in the art that have not yet been fully identified, appreciated, or solved by current flywheel systems. For example, one or more embodiments of the present invention pertain to a bearing system configured to safely spin down a magnetically suspended flywheel rotor from full speed when the magnetic suspension fails, the power is shut off, or the forces on the flywheel exceed the magnetic suspension capability.

In one embodiment, an apparatus is provided. The apparatus includes a plurality of touchdown wheels mounted on a mounting structure in a planetary arrangement. The mounting structure is mounted to a stationary structure of a flywheel system.

In another embodiment, an apparatus is provided. The apparatus includes a plurality of touchdown wheels that connects to a touchdown bearing in a planetary configuration. The touchdown bearing includes a mounting structure and a stationary structure.

In yet another embodiment, an apparatus is provided. The apparatus includes a plurality of wheels that are configured to mount in a planetary configuration on a mounting structure. The mounting structure is configured to mount to a stationary structure using a plurality of wave springs axially and marcel expander spring radially to provide desired radial and axial stiffness and friction damping.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a touchdown bearing, according to an embodiment of the present invention.

FIG. 2 illustrates a cross-sectional view of the touchdown bearing, according to an embodiment of the present invention.

FIGS. 3A and 3B illustrate cross-sectional views of the touchdown bearing, according to an embodiment of the present invention.

FIG. 4 illustrates a free body diagram of the touchdown bearing, according to one embodiment of the present invention.

FIG. 5 illustrates a force profile of the touchdown bearing, according to one embodiment of the present invention.

### DETAILED DESCRIPTION OF THE EMBODIMENTS

Flywheel systems that are magnetically levitated require a backup mechanical bearing system, e.g., a touchdown bearing or backup bearing. During normal operating, when the power is off and the flywheel is not spinning, the flywheel system rests on the mechanical bearing. The mechanical bearing may also be used when flywheel is operating and there is a substantial failure in the internal system of the flywheel. This may allow the flywheel system to safely shutdown.

However, traditional touchdown bearing systems have issues with high flywheel rotor operating speeds, open core flywheel topology, and rotordynamic response. The touchdown bearing described herein addresses the issues associated with high rotational speed requirements, tailorable mounting stiffness and damping to address rotordynamics requirements. The touchdown bearing described herein may also be used with an open core flywheel design, as well as a traditional shafted flywheel rotor design.

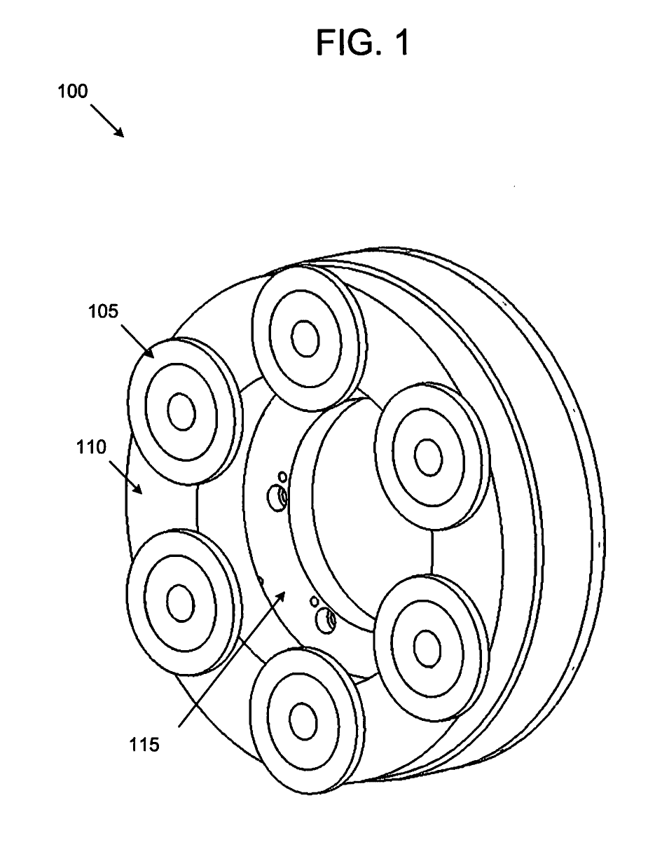

FIG. 1 illustrates a touchdown bearing 100, according to an embodiment of the present invention. In this embodiment, touchdown bearing 100 may be a high speed, compliant, planetary flywheel touchdown bearing.

Touchdown bearing 100 includes a plurality of touchdown wheels 105 that may contact a spinning flywheel rotor (not shown). Each of plurality of touchdown wheels 105 may contain a high strength steel or high strength composite material that has an equal or greater speed rating than the flywheel rotor material. This may allow the matching of the surface speeds of the outer diameter when plurality of touchdown wheels 105 contacts the flywheel rotor.

In one embodiment, each of plurality of touchdown wheels 105 are mounted to a mounting structure (e.g., a rigid support ring) 110 in a planetary arrangement. A planetary arrangement with a minimum of three wheels allows the rotor to be captured in both radial degrees of freedom. It should be appreciated that mounting structure 110 provides proper stiffness and damping for each of plurality of wheels 105. In certain embodiments, stiffness and damping may be set or optimized for each application of touchdown bearing 100 to minimize force and vibration, or displacement, of the flywheel rotor during spin down.

In a traditional shafted flywheel design, the wheel is mounted on a central axle or shaft which protrudes from each end of the wheel. The flywheel motor, magnetic bearings and touchdown bearings are mounted on the shaft ends. In an open core design, the wheel has an annular shape with the motor, magnetic bearings and touchdown bearings inside. This causes the traditional touchdown bearing design to have issues supporting an “open core” flywheel design and a “shafted design.”

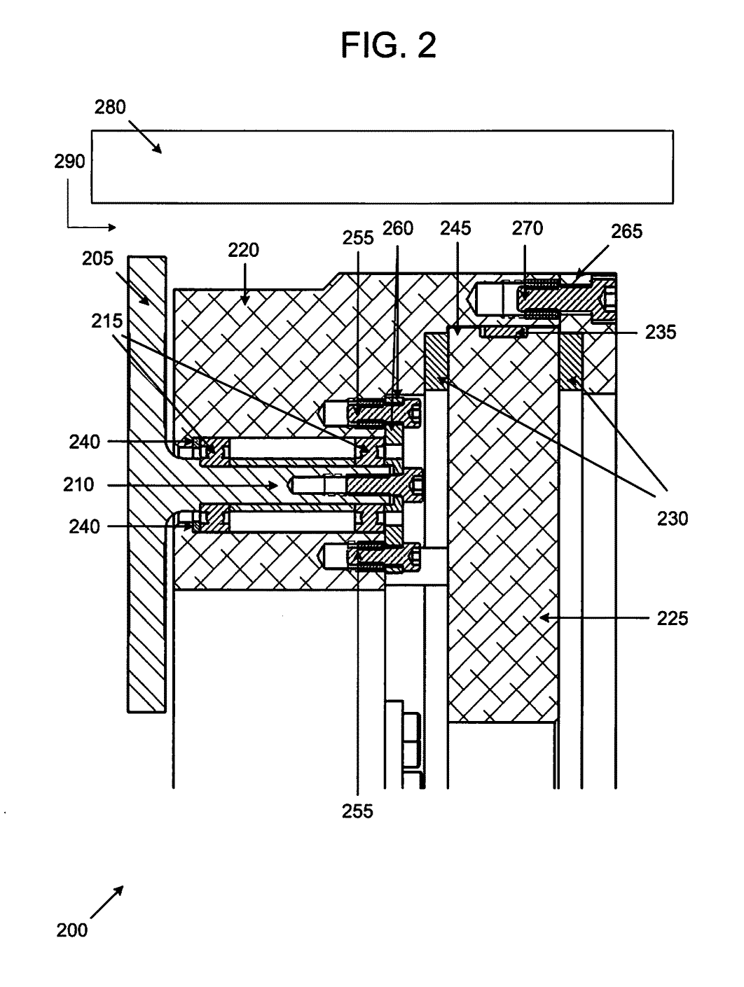

This embodiment addresses the ability to support both an “open core” flywheel design (see FIG. 2), as well as a traditional “shafted design.” For example, by employing a planetary configuration of touchdown wheels 105, touchdown bearing 100 may support an open core design where a touchdown clearance gap exists between the shaft and the outer sides of touchdown wheels 105. FIG. 2 shows an open core design. For example, 280 is a flywheel rotor, the centerline of the drawing would be at the bottom of the page. Mounting structure 110 is compliantly mounted to a stationary structure 115 of a flywheel system.

FIG. 2 shows a cross-sectional view of a touchdown bearing 200, according to an embodiment of the present invention. In this embodiment, a touchdown wheel 205 may include an axle 210 (protruding from left to right). Because touchdown wheel 205 uses an axle arrangement, a through hole in the center of touchdown wheel 205 is not required. As a result, the operating speed of touchdown wheel 205 is increased.

Ball bearings 215, in this embodiment, are high speed bearings, and utilize high speed angular contact bearings with a spring preload. Because touchdown wheel 205 has an axle mounted to two sets of ball bearings 215, touchdown wheel 205 may be mounted to a mounting structure 220 and, as a result, the touchdown wheel 205 may rotate at higher speeds than conventional touchdown bearing systems. Bolts 255 may be configured to hold or capture ball bearings 215, as well as secure retainer plate 260. Retainer plate 260 may retain an angular contact bearing.

It should be noted that for a high speed flywheel, a key metric is the surface speed of the rotor system, which is a product of the revolutions per minute (RPM) and the diameter of the rotor. With utilization of high strength materials, such as carbon fiber, the surface speeds can be in the range of 1,000 to 1,500 m/s. Because conventional touchdown bearing systems have issues operating at such surface speeds, features have to be added to the flywheel rotor to accommodate lower bearing surface speeds. For example, such features may include smaller diameter shafts or arbor structures that can bridge the wheel diameter down to the bearing size.

Embodiments described herein resolve the speed mismatch between flywheel rotor 280 and touchdown bearing 215 by adding touchdown wheels 205 on touchdown bearing 215 instead of adding additional parts to flywheel rotor 280. This allows flywheel rotor 280 to be optimized for maximum energy density. By mounting touchdown wheel 205 on touchdown bearing 215, the effective surface speed is higher than the bearing because touchdown wheel 205 can be made at a larger diameter using the same material and design practices as the flywheel rotor.

To provide a desired radial and axial stiffness and friction damping for touchdown wheel 205, mounting structure 220 is compliantly mounted to a stationary structure 225 using wave springs 230 axially and a marcel expander spring 235 radially. Stated differently, marcel expander spring 235 controls radial stiffness and damping, while wave springs 230 control axial stiffness and damping. It should be noted that wave springs 240 also control axial stiffness. Wave spring 240 is used to properly preload the high speed angular contact bearings.

An end cap 265 retained by bolt 270 is used to retain one of the wave springs 230 as well as serve as one part of the dead stop feature. It should be appreciated that the other wave spring 230 may be retained by mounting structure 220 and stationary structure 225.

The travel of mounting structure 220 is also limited by dead stop features (e.g. dead stop area) in both axial and radial directions, to positively limit travel in case the loads on wave springs 230 and marcel expander springs 235 are exceeded. One axial and radial dead stop area is a region between a shoulder 245 and the housing of bearing 200. The other axial and radial dead stop area is a region between shoulder 245 and end cap 265. Stated differently, shoulder 245 is located around marcel expander spring 235.

It should be appreciated that the axial stiffness and radial stiffness of wave springs 230 and marcel expander spring 235 are selected such that the flywheel rotor is limited to the extent that the flywheel rotor does not contact any other part of a touchdown stator (not shown) other than touchdown wheels during shutdown of the magnetic suspension system. Further, the axial and radial stiffness are selected such that no unstable rotor dynamic modes exist in the operating speed range of the flywheel rotor while it spins down on touchdown bearing 200.

In certain embodiments, the axial and radial stiffness may also be selected to minimize the forces transmitted to the flywheel stator. In this embodiment, the axial and radial springs (e.g., waive springs 230 and marcel expander spring 235) are located near the same diameter as the contact surface between touchdown wheel 205 and flywheel rotor 280 to optimize the dimensions of the touchdown clearance gap, the spring range, and the dead stop area. In certain embodiments, the stiffness and damping are selected or optimized for each application to minimize force and vibration, or displacement, of flywheel rotor 280 during spin down.

It should be noted that a clearance gap 290 may exist between touchdown wheel 205 and a flywheel rotor 280. For example, when the magnetic bearing (not shown) is working correctly, touchdown wheel 205 and flywheel rotor 280 are not engaged. However, when the magnetic bearing fails, for example, the flywheel rotor 280 may drop down onto touchdown wheel 205, such that touchdown wheel 205 supports flywheel rotor 280. This may allow flywheel rotor 280 to spin down over a period of time.

It should be appreciated that touchdown bearing 200, in this embodiment, has a tailorable rotordynamic response. For example, touchdown clearance gap 290 sets the amount of travel flywheel rotor 280 is allowed before touchdown bearing 200 is engaged. Axial wave springs 230 and marcel expander spring 235 are configured to set a stiffness and damping of touchdown bearing 200. The dead stop area sets the maximum travel or displacement of touchdown bearing 200. By properly selecting these parameters, the flywheel rotordynamic modes can be set outside of the normal operating speed range. Also, the dynamic response can be tailored to limit the transmitted force to the flywheel stator and the travel of the flywheel rotor. Also, by setting these parameters, unstable modes that lead to excessive forces on the flywheel system can be avoided.

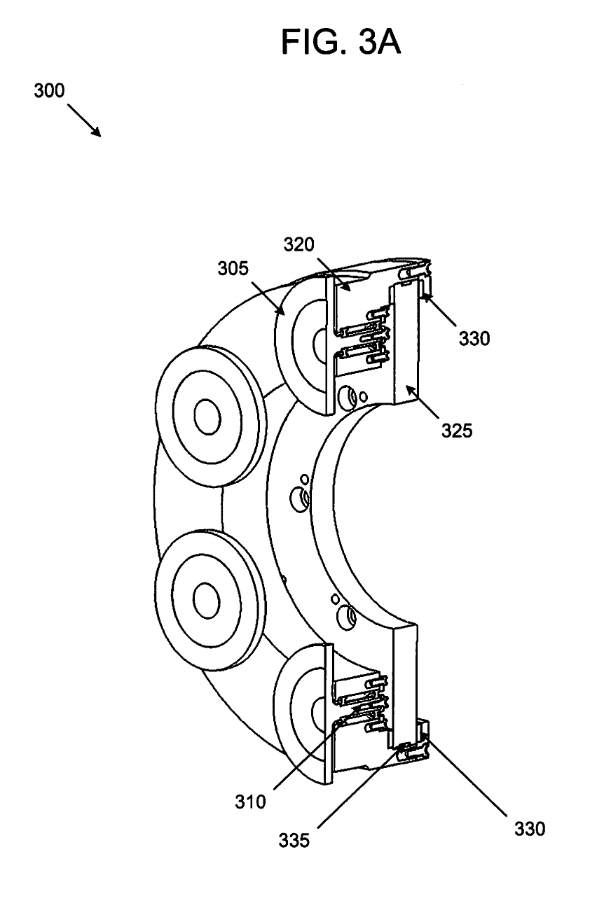

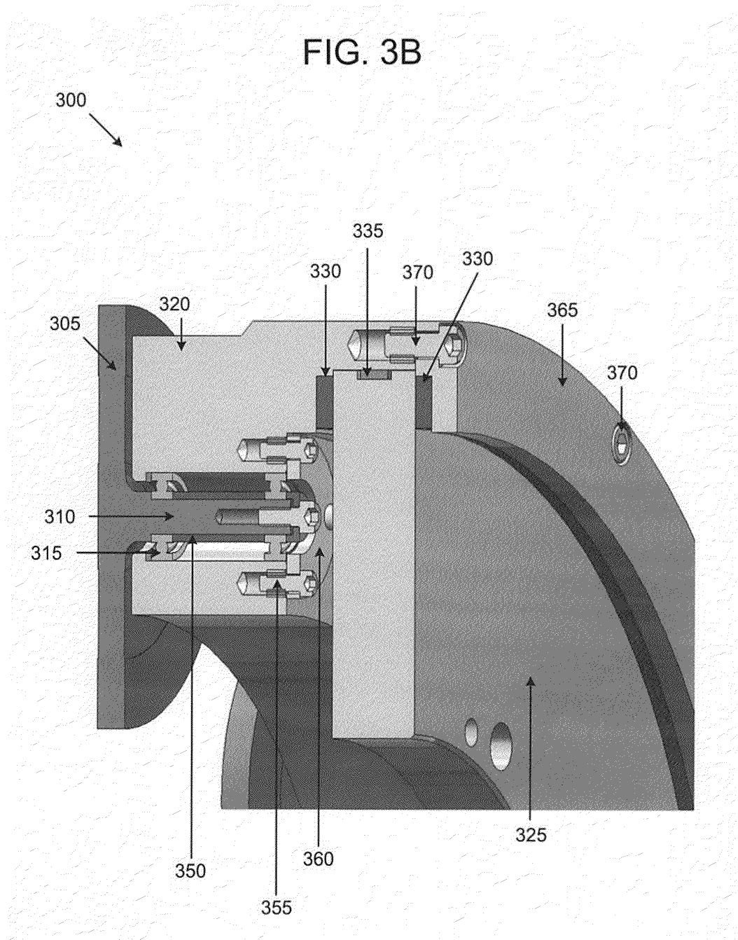

FIGS. 3A and 3B illustrate cross-sectional views of a touchdown bearing 300, according to an embodiment of the present invention. This embodiment includes similar components described above with respect to FIG. 2. For example, FIGS. 3A and 3B show that plurality touchdown wheel(s) 305 include an axle 310 that allows each of plurality of touchdown wheel(s) 305 to be mounted to a mounting structure 320. Mounting structure 320 may be mounted to a stationary structure 325 using wave springs 330 axially and marcel expander spring 335 radially to provide a desired radial and axial stiffness and friction damping. As discussed above, this may minimize the force and vibration, or displacement, of the flywheel rotor during spin down.

Shown more clearly in FIG. 3B is an end cap 365 that is retained by bolts 370. End cap 365 may retain one of the wave springs 330 and serve as one part of the dead stop feature discussed above. It should be appreciated that the other wave spring 330 may be retained by mounting structure 320 and stationary structure 325. Bolts 355 and retaining unit 350 may hold or capture ball bearings 315. Bolts 355 may also secure retainer plate 360 allowing retainer plate 360 to retain an angular contact bearing.

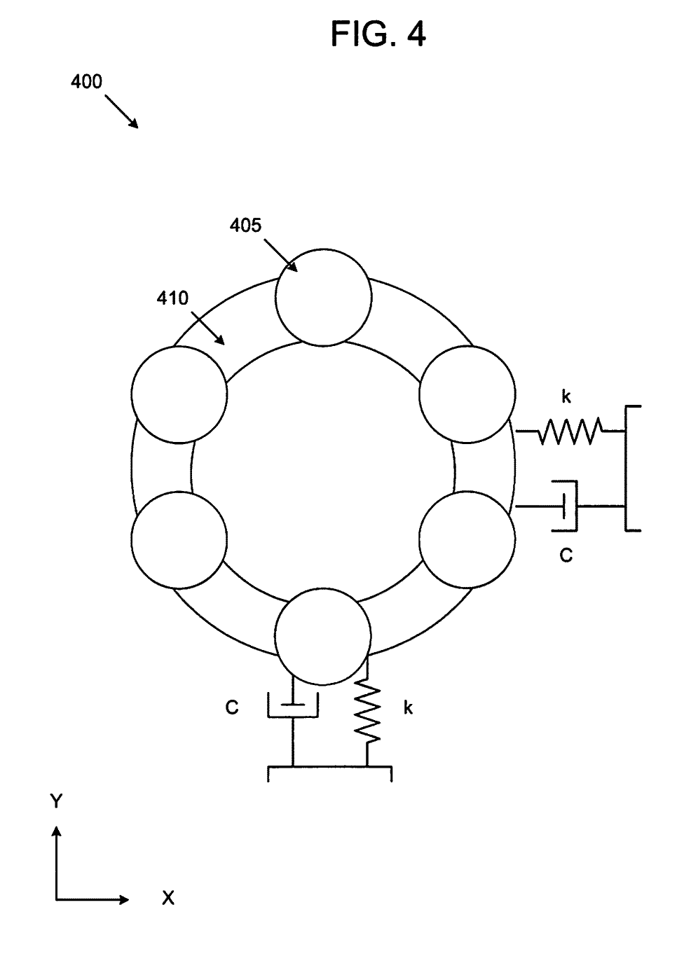

FIG. 4 illustrates a free body diagram of a touchdown bearing 400, according to one embodiment of the present invention. This diagram shows how the mounting structure works with respect to touchdown bearing 400 having a plurality of touchdown wheels 405 mounted to a mounting structure 410. For example, the configuration of the springs in this embodiment allow for spring k and damping c features in both an x and y plane.

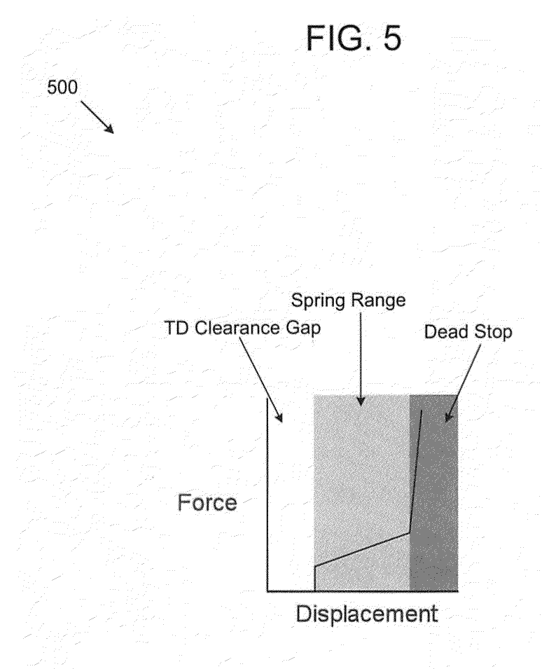

FIG. 5 illustrates a force profile of touchdown bearing 500, according to one embodiment of the present invention. The force profile shows that there is no force in the clearance gap because there is no contact between the touchdown wheels and the rotor. As the touchdown wheels and rotor come in contact, the force profile shows that the force is related to the spring and dampers of FIG. 4. Force profile also shows that if there is too much movement in the limits of the dead stop area, then there may be severe force to prevent the touchdown bearing to move any further.

One or more embodiments of the present invention pertain to a touchdown bearing designed to provide an auxiliary mechanical bearing system for magnetically suspended flywheel systems. In certain embodiments, a plurality of touchdown wheels are mounted in a planetary configuration on a support ring. The support ring may be compliantly mounted to a stationary structure of the flywheel system using wave springs axially and marcel expander springs radially to provide a desired radial and axial stiffness and friction damping.

It will be readily understood that the components of the invention, as generally described and illustrated in the figures herein, may be arranged and designed in a wide variety of different configurations. Thus, the detailed description of the embodiments is not intended to limit the scope of the invention as claimed, but is merely representative of selected embodiments of the invention.

The features, structures, or characteristics of the invention described throughout this specification may be combined in any suitable manner in one or more embodiments. For example, the usage of “certain embodiments,” “some embodiments,” or other similar language, throughout this specification refers to the fact that a particular feature, structure, or characteristic described in connection with an embodiment may be included in at least one embodiment of the invention. Thus, appearances of the phrases “in certain embodiments,” “in some embodiments,” “in other embodiments,” or other similar language, throughout this specification do not necessarily all refer to the same embodiment or group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations that are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An apparatus, comprising:
a plurality of touchdown wheels configured to mount on a mounting structure in a planetary arrangement; wherein
the mounting structure is configured to mount on a stationary structure of the apparatus.

2. The apparatus of claim 1, wherein each of the plurality of touchdown wheels comprises high strength steel or high strength composite material having equal or greater speed rating than a material of a flywheel rotor.

3. The apparatus of claim 1, wherein each of the plurality of touchdown wheels comprises an axle mounted to two sets of ball bearings to allow the each of the plurality of touchdown wheels to operate at high speeds when engaged with a flywheel rotor.

4. The apparatus of claim 1, wherein the mounting structure and stationary structure are mounted using a plurality of wave springs axially and a marcel expander spring radially to provide a desired radial and axial stiffness and friction damping.

5. The apparatus of claim 4, wherein the plurality of wave springs and the marcel expander spring comprise a radial and axial stiffness configured to limit a flywheel rotor from contacting a flywheel stator during shutdown of a magnetic suspension system, to prevent unstable rotor dynamic modes when a flywheel rotor engages the plurality of touchdown wheels, and to minimize force transmitted to the flywheel stator.

6. The apparatus of claim 1, further comprising:
a touchdown clearance gap between the plurality of touchdown wheels and a flywheel rotor, and configured to prevent the apparatus and the flywheel rotor from being engaged during normal operation of the flywheel rotor.

7. The apparatus of claim 1, further comprising:
a dead stop area configured to limit travel of the mounting structure in both an axial and radial direction.

8. An apparatus, comprising:
a plurality of touchdown wheels configured to mount on a touchdown bearing in a planetary configuration, wherein the touchdown bearing comprises a mounting structure and a stationary structure.

9. The apparatus of claim 8, wherein each of the plurality of touchdown wheels comprises high strength steel or high strength composite material having equal or greater speed rating than a material of a flywheel rotor.

10. The apparatus of claim 8, wherein mounting structure and the stationary structure are connected via a plurality of wave springs and a marcel expander spring.

11. The apparatus of claim 10, wherein the plurality of wave springs and marcel expander spring comprises a radial and axial stiffness configured to limit a flywheel rotor from contacting a flywheel stator during shutdown of a magnetic suspension system, to prevent unstable rotor dynamic modes when a flywheel rotor engages the plurality of touchdown wheels, and to minimize force transmitted to the flywheel stator.

12. The apparatus of claim 8, further comprising:
a touchdown clearance gap between the plurality of touchdown wheels and a flywheel rotor, and configured to prevent the apparatus and the flywheel rotor from being engaged during normal operation of the flywheel rotor.

13. The apparatus of claim 8, further comprising:
a dead stop area configured to limit travel of the mounting structure in both an axial and radial direction.

14. An apparatus, comprising:
a plurality of wheels configured to mount in a planetary configuration on a mounting structure, wherein
the mounting structure is configured to mount to a stationary structure using a plurality of wave springs axially and marcel expander spring radially to provide desired radial and axial stiffness and friction damping.

15. The apparatus of claim 14, wherein each of the plurality of wheels comprises high strength steel or high strength composite material having equal or greater speed rating than a material of a flywheel rotor.

16. The apparatus of claim 14, wherein each of the plurality of wheels comprises an axle mounted to two sets of high speed ball bearings to allow the each of the plurality of wheels to operate at high speeds when engaged with a flywheel rotor.

17. The apparatus of claim 14, wherein the plurality of wave springs and the marcel expander spring comprise a radial and axial stiffness configured to limit a flywheel rotor from contacting a flywheel stator during shutdown of a magnetic suspension system, to prevent unstable rotor dynamic modes when a flywheel rotor engages the plurality of touchdown wheels, and to minimize force transmitted to the flywheel stator.

18. The apparatus of claim 14, further comprising:
a touchdown clearance gap between the plurality of wheels and a flywheel rotor, and configured to prevent the apparatus and the flywheel rotor from being engaged during normal operation of the flywheel rotor.

19. The apparatus of claim 14, further comprising:
a dead stop area configured to limit travel of the mounting structure in both an axial and radial direction.

20. The apparatus of claim 14, wherein the plurality of wave springs are configured to control axial stiffness and damping, and the marcel expander spring controls the radial stiffness.
